(19) United States
(12) Patent Application Publication
(10) Pub. No.: US 2010/0075143 A1
(43) Pub. Date: Mar. 25, 2010

(54) FIBER STRUCTURE AND METHOD FOR PRODUCTION THEREOF

(75) Inventors: Takafumi Hashimoto, Shiga (JP); Shuichi Nonaka, Shiga (JP); Hiromichi Iijima, Shiga (JP); Kakuji Murakami, Shiga (JP)

Correspondence Address: RATNERPRESTIA, P.O. BOX 980, VALLEY FORGE, PA, 19482, US

(73) Assignee: Toray Industries, Inc., Tokyo (JP)

(21) Appl. No.: 12/529,831

(22) PCT Filed: Mar. 5, 2008
(86) PCT No.: PCT/JP2008/053910

§ 371 Date: Sep. 3, 2009

(30) Foreign Application Priority Data
Mar. 7, 2007 (JP) 2007-056809
Jun. 29, 2007 (JP) 2007-171607

(51) Int. Cl. D02G 3/22; B29C 47/00

(52) U.S. Cl. 428/369; 264/211.22

(57) ABSTRACT

A fiber structure including: (A) a single fiber having a fiber diameter of 3 μm or more and/or a fiber bundle having a fiber bundle diameter of 3 μm or more, and (B) a single fiber having a fiber diameter of 1 μm or less, wherein the component (A) has a number average fiber diameter and/or a number average fiber bundle diameter of 4 μm or more, at least a part of the component (B) is dispersed in the component (A) in a monofilamentous state in the cross-section taken in the thickness-wise direction of the fiber structure, at least a part of the component (B) dispersed in the monofilamentous state is bent and/or tangled to form a void space, and at least one surface of the fiber structure is covered with the component (B).

### FIELD OF THE INVENTION

The present invention relates to a fiber structure in which fibers are dispersed in a monofilamentous state, and a method for production thereof.

### BACKGROUND OF THE INVENTION

Heretofore, so-called microfibers having a single fiber diameter of 2 to 5 μm have been suitably used for eyeglass wipers, display wiping clothes for lens and electronic equipment, and the like. Recently, wiping clothes made of combined filament yarns of microfibers and high shrinkage yarns have been proposed to improve wiping properties and dimensional stability by the densification of fabrics (Patent Document 1).

However, the conventional wiping clothes sometimes scratch an object itself by a wiping operation depending on the object. Further, in the case of wiping in everyday life, foreign matters are put between a wiping cloth and an object during wiping and larger scratch is likely to be made. Therefore, a range of application of the conventional wiping clothes is limited to glasses, liquid crystal displays of domestic digital video cameras, and the like, and there has been a problem that the conventional wiping clothes cannot be applied to objects which are soft and easily scratched, for example, contact lens, silver products, and the like.

Furthermore, the conventional wiping clothes have had not satisfactory wiping properties for stains in fine unevennesses of the object. It is considered that, since the conventional microfibers have a single fiber diameter of about 2 to 5 μm and, when pressed against the object, stress concentration is likely to occur on the surface of the object, scratches are likely to be made. It is also considered that, when foreign matters are put between a wiping cloth and an object, since the foreign matters are pressed against them, and then are in a state of being polished by the foreign matters, scratches are likely to occur. It is also presumed that, when stains penetrate into micro-level unevennesses of an object, even if a microfiber single fiber has a smaller size than that of the unevenness, since bending stiffness of the microfiber is still large, the microfiber cannot penetrate along the unevennesses in a bent state and therefore stains cannot be scraped, resulting in insufficient wiping properties.

In contrast, a wiping cloth including so-called nanofibers made of an organic polymer and having a number average single fiber diameter of 1 to 500 nm has been proposed (Patent Document 2).

Although each nanofiber included in the wiping cloth has a nano order diameter, the nanofiber has a very strong cohesive power and a fiber structure is present as a bundle having a diameter of several micron meters in which several hundreds to several tens of thousands of nanofibers are assembled. Therefore, problems of a wiping cloth using the above microfibers have been solved to some extent, but it is not completely satisfactory.

On the other hand, regarding hard disks, silicon wafers, integrated circuit boards, precision instruments and optical components, higher performances are required and thus higher precision of surface processing of a substrate is required. Higher precision of surface processing of a substrate as used herein is mainly, for example, an improvement in smoothness of a substrate surface and reduction of scratches. As means for solving these problems, for example, those in a woven fabric form produced by using ultrafine fibers (micron level) (for example, Patent Document 3) and those in a nonwoven fabric form (for example, Patent Document 4) are disclosed. By using ultrafine fibers, a force applied to abrasive grains is dispersed or agglomeration of abrasive grains and production of polishing wastes, which cause scratches, are suppressed. Although these techniques exert some effects, further improvement is required.

A polishing cloth using nanofibers as thinner fibers is also disclosed. Also in this case, similar to the case of the wiping cloth, since nanofibers are in a bundle state, an original small fiber diameter cannot be sufficiently utilized and sufficient effects cannot be obtained.

Although it is known to inject a high-pressure fluid flow into a fabric containing ultrafine fibers, the object and effects are different from those provided by the present invention.

For example, Patent Document 5 discloses a method for producing an extremely ultrafine fiber woven and knitted fabric including making a woven and knitted fabric composed mainly of yarns consisting of extremely ultrafine fibers having 0.2 to 0.00001 deniers, and injecting a liquid of at least 5 to 200 Kg/cm² into the woven and knitted fabric through small pores to contract the woven and knitted fabric. However, since the technique aims at tangling ultrafine fibers included in the woven fabric, it is described that fibers are unfavorably cut when a fluid has too high pressure.

Patent Document 6 discloses a fabric for skin cleaning, including synthetic fibers having a single fiber fineness of 0.001 dtex or more and 1.0 dtex or less, the fabric being composed of a knitted and woven fabric subjected to a high-pressure water flow treatment; and a method for production thereof including treating a fabric which is woven or knitted by using composite fibers having a sea-island structure or a release structure in hot water or an alkali solution, thereby removing or releasing a sea component, and subjecting the fabric to a high-pressure water flow treatment. As is apparent from the method, the ultrafine fiber of the technique is a continuous yarn and the technique aims at properly increasing a fiber space.

Further, Patent Document 7 discloses an artificial leather including a nanofiber assembly in which a number average single yarn fineness is 1.3×10⁻⁵ to 3.2×10⁻⁴ dtex and the sum of a single yarn fineness ratio (a single yarn fineness of 1.3×10⁻⁵ to 3.2×10⁻⁴ dtex) is 60% or more. In the patent document, there is described that a high-pressure water flow treatment may be conducted. However, such a high-pressure water flow treatment aims at tangling fibers constituting a fiber structure, thereby enhancing tenacity of the fiber structure or orienting the fibers in the thickness-wise direction of the fiber structure to improve texture, and a tangling treatment is conducted prior to exhibit of ultrafine fibers by removing one component from a polymer alloy fiber.

Also, a polishing pad made of a resin containing fine pores therein such as polyurethane, and a polishing pad obtained by impregnating a nonwoven fabric composed of fibers having a comparatively large fiber diameter with a resin such as polyurethane are proposed (see, for example, Patent Document 8). However, a polishing pad which satisfies all of smoothness of a polished surface, reduction in defects such as scratches, and polishing efficiency has never been obtained.

For the purpose of discharging polishing wastes and agglomerated abrasive grains produced by polishing, such a polishing pad has a structure in which pores occupy a large portion of the surface. Such a structure is advantageous for discharging polishing wastes and agglomeration abrasive grains, but has a problem that abrasive grains required for polishing are also discharged simultaneously, resulting in low efficiency in use of abrasive grains.

Patent Document 1: Japanese Unexamined Patent Publication (Kokai) No. 9-19393

Patent Document 2: Japanese Unexamined Patent Publication (Kokai) No. 2005-307379

Patent Document 3: Japanese Unexamined Patent Publication (Kokai) No. 11-90810

Patent Document 4: Japanese Unexamined Patent Publication (Kokai) No. 2003-236739

Patent Document 5: Japanese Unexamined Patent Publication (Kokai) No. 60-39439

Patent Document 6: Japanese Unexamined Patent Publication (Kokai) No. 2005-23435

Patent Document 7: Japanese Unexamined Patent Publication (Kokai) No. 2004-256983

Patent Document 8: Japanese Unexamined Patent Publication (Kokai) No. 3-234475

### SUMMARY OF THE INVENTION

The present invention provides a fiber structure in which ultrafine fibers are not in a bundle state and are dispersed in a monofilamentous state, and a method for production thereof. According to embodiments of the present invention, since original features of the ultrafine fibers, for example, flexibility and a high surface area of fibers can be maximally exhibited, a fiber structure suited for a polishing cloth and a cleaning cloth can be obtained. When such a fiber structure is used as a polishing cloth, abrasive grains can be efficiently utilized and also polishing with little defects such as scratches can be conducted, and is therefore useful as a polishing cloth excellent in smoothness and a polishing rate. The fiber structure is also used as a wiping cloth having excellent stain removal properties.

Embodiments of the present invention may be characterized by the following constitutions.

(1) A fiber structure including: A) a single fiber having a fiber diameter of 3 μm or more and/or a fiber bundle having a fiber bundle diameter of 3 μm or more, and (B) a single fiber having a fiber diameter of 1 μm or less, wherein the component (A) has a number average fiber diameter and/or a number average fiber bundle diameter of 4 μm or less, at least a part of the component (B) is dispersed in the component (A) in a monofilamentous state in the cross-section taken in the thickness-wise direction of the fiber structure, at least a part of the component (B) dispersed in the monofilamentous state is bent and/or tangled to form a void space, and at least one surface of the fiber structure is covered with the component (B).
(2) The fiber structure according to the above-mentioned (1), wherein the fiber bundle of the component (A) is composed of a single fiber having a number average fiber diameter of 1 μm or less.
(3) The fiber structure according to the above-mentioned (1) or (2), wherein the void space formed by bends and/or tangles is a void space surrounded only by a fiber whose cross-section cannot be observed, although a fiber whose cross-section can be observed and a fiber whose cross-section cannot be observed exist when the cross-section of the fiber structure is observed on a SEM photograph.
(4) The fiber structure according to any one of the above-mentioned (1) to (3), wherein a light reflectance of a surface is 80% or more.
(5) The fiber structure according to any one of the above-mentioned (1) to (4), wherein air permeability is 2 cc/cm²/sec or less.
(6) A method for production of a fiber structure, which comprises forming a fiber structure containing a polymer alloy fiber composed of a plurality of polymers each having a different solubility; removing at least one kind of a polymer among the plurality of polymers each having a different solubility of the polymer alloy fiber, to develop an ultrafine fiber having a fiber diameter of 10 to 1,000 nm to give a fiber bundle consisting of the assembled ultrafine fibers; and injecting a high-pressure fluid flow at 0.1 to 20 MPa into the fiber structure containing the fiber bundle consisting of the assembled ultrafine fibers.
(7) The method for production of a fiber structure according to the above-mentioned (6), wherein the polymer alloy fiber is obtained by converting the plurality of polymers each having a different solubility into a polymer alloy using an extrusion kneader and/or a static kneader, followed by spinning.
(8) The method for production of a fiber structure according to the above-mentioned (6) or (7), wherein the fiber bundle consisting of the assembled ultrafine fibers is a fiber bundle in which a number average fiber diameter is from 10 to 300 nm, and a number ratio of the ultrafine fiber having an fiber diameter of 10 to 300 nm is 60% or more.
(9) The method for production of a fiber structure according to the above-mentioned (6), wherein the fiber structure according to the above-mentioned (1) is produced.

According to embodiments of the present invention, it is possible to easily obtain a fiber structure in which ultrafine fibers are dispersed on a single fiber. When such a fiber structure is used as a polishing cloth, a polishing load is dispersed in the ultrafine fibers dispersed in a monofilamentous state, and thus uniform polishing with high smoothness can be conducted. Further, since moderate void spaces exist between the ultrafine fibers, the fiber structure has a high ability of holding abrasive grains. When the fiber structure is used as a polishing cloth, agglomeration of abrasive grains is suppressed and scratches are less likely to be made. When the fiber structure is used as a wiper, the fiber structure has a high ability of trapping stains.

The fiber structure of an embodiment of the present invention has a lot of very small void spaces between fibers compared to a conventional fiber structure used for a polishing cloth, and the like, and is dense. Therefore, fine particles are less likely to penetrate into the fiber structure and. When the fiber structure is used as a polishing cloth, the proportion of abrasive grains held on the surface of the fiber structure is large, and thus polishing with uniformity the fiber structure is and high efficiency can be conducted. The fiber structure has fine space and therefore has moderate flexibility and cushioning properties, and is advantageous for improving smoothness of articles to be polished and reduction in scratches. The fiber structure is excellent in tenacity since thick single fibers or fiber bundles exist in the fiber structure. Furthermore, the fiber structure is excellent in wiping performances when the fiber structure is used as a wiping cloth and can provide a high-performance polishing cloth which causes little no-wiped portion.

### BRIEF DESCRIPTION OF THE DRAWINGS

FIG. 1 is a SEM photograph showing a cross-sectional shape of a composite sheet I produced in Example 1.

FIG. 2 is a SEM photograph showing a cross-sectional shape of a woven fabric II produced in Example 4.

FIG. 3 is a SEM photograph showing a cross-sectional shape of a woven fabric II produced in Comparative Example 2.

FIG. 4 is a high-magnification SEM photograph showing a cross-sectional shape of a woven fabric II produced in Example 4.

### EXPLANATION OF LETTERS OR NUMERALS

1: Example of a fiber dispersed in a monofilamentous state in the composite sheet II produced in Example 1
2: Example of a fiber bundle in a composite sheet II produced in Example 1
3: Example of a fiber in a short fiber nonwoven fabric in the composite sheet II produced in Example 1
4: Example of a fiber bundle in a woven fabric II produced in Example 4 (black portion)
5: Example of a fiber dispersed in a monofilamentous state in the woven fabric II produced in Example 4 (portion visualized to be white)
6: Assembly of fiber bundles in the woven fabric II produced in Example 4
7: Example of a fiber bundle in the woven fabric II produced in Example 4
8: Example of a fiber dispersed in the monofilamentous state and a void space formed by a bend/tangle thereof in the woven fabric II produced in Example 4

### DETAILED DESCRIPTION OF THE INVENTION

A fiber structure and a method for production thereof according to the present invention will be hereinafter described in detail by way of exemplary embodiments.

A fiber as a component (A) in the fiber structure of an embodiment of the present invention refers to a single fiber having a fiber diameter of 3 μm or more and a number average fiber diameter of 4 μm or more, or a fiber bundle having a fiber bundle diameter of 3 μm or more and a number average fiber bundle diameter of 4 μm or more, or both of them (hereinafter may be usually referred to as a fiber and/or a fiber bundle).

Further, A fiber as a component (B) refers to a single fiber having a fiber diameter of 1 μm or less (hereinafter may be referred to as an ultrafine fiber).

A structure having these components (A) and (B) are formed into a sheet and, in the cross-section taken in the thickness-wise direction of the fiber structure, at least a part of the component (B) is usually dispersed (monodispersed) in a monofilamentous state between the fiber and/or fiber bundle as the component (A).

When the single fiber or fiber bundle as the component (A) is too thin, the objective effect of improving the strength of the fiber structure of exemplary embodiments of the present invention is not obtained. Therefore, it is beneficial that the fiber as the component (A) has a single fiber diameter or a fiber bundle diameter of 3 μm or more and a number average fiber diameter or a number average fiber bundle diameter of 4 μm or more. When the single fiber or fiber bundle as the component (A) is too thick, smoothness of the surface of the fiber structure tends to deteriorate and therefore the number average fiber diameter or number average fiber bundle diameter of the component (A) is preferably 20 μm or less. Also, a fiber structure containing only fibers as the component (A) may have a surface with insufficient smoothness and, when used as a polishing cloth, void spaces between fibers become large and uniform retentiveness of abrasive grains deteriorates and a polishing pressure applied to abrasive grains is not easily dispersed. Therefore, it is advantageous that the fiber structure of an embodiment of the present invention includes ultrafine fibers (B) having a single fiber diameter of 1 μm or less. When the fibers (B) are too thin, abrasion resistance of a surface tends to deteriorate and thus the number average fiber diameter of the fibers (B) is preferably 10 nm or more.

In an embodiment of the present invention, the single fiber diameter or fiber bundle diameter is determined by observing the surface or cross-section of the fiber structure using a transmission electron microscope (TEM) or a scanning electron microscope (SEM) and using image processing software, or the like, or directly measuring it on a printed photograph. The number average fiber diameter or number average fiber bundle diameter is determined by measuring the single fiber diameter or fiber bundle diameter of 30 samples obtained at random on the same surface or in the cross-section using the similar method, and determining the simple average, which is taken as the number average fiber diameter or number average fiber bundle diameter. When the cross-section of the fiber is not complete round, the cross-sectional area of the fiber is determined and the diameter of a circle equivalent to the area is taken as a fiber diameter of the fiber.

The term “fiber bundle” refers to a fiber assembly in which a plurality of single fibers are uniformly arranged in the substantially same direction as that of a fiber longitudinal direction substantially without clearance. The term “state in which single fibers are arranged substantially without clearance” refers to a state in which the sum of the area of clearance between single fibers is 10% or less of a cross-sectional area of a fiber assembly in the cross-section of fibers in the fiber assembly. When the cross-section of the fiber structure is observed after cutting, it is necessary to use a sharp cutter, if possible, after freezing the fiber structure by dipping in liquid nitrogen so as to suppress fusion of fibers.

In the case of a fiber bundle, in which single fibers are assembled very densely and, when the single fibers constituting the fiber bundle are very thin or composed of a polymer having a comparatively low melting point, for example, an ultrafine fiber bundle, the fibers are fused each other when the cross-section is cut, and thus no clearance may be observed in the fiber bundle. In such a case, the clearance between the fibers is regarded as zero.

The fiber structure of an embodiment of the present invention can usually have sufficient tenacity suited for a polishing cloth or a wiping cloth by the existence of the fiber and/or fiber bundle as the component (A). In addition, dropping-off of ultrafine fibers can be suppressed when the fiber structure is used as the polishing cloth or wiping cloth by coexistence of ultrafine fibers (B) dispersed in a monofilamentous state and the fiber and/or fiber bundle. For the purpose of more suppressing dropping-off of the ultrafine fibers, it is possible to contain, as a binder, a resin such as polyurethane. However, in the case where the ultrafine fibers are fixed by tangles or fusion, when agglomerated abrasive grains or polishing wastes, which can cause scratches, exist, a force applied on articles to be polished can be mitigated by movement of fibers. As a result, polishing with high smoothness and less defects such as scratches can be conducted, and thus it is preferred that the ultrafine fibers are not fixed by a resin.

The term “fibers dispersed in a monofilamentous state” as used herein refers to fibers in which each single fiber separately exits, substantially. The following procedure determines whether or not fibers are dispersed in a monofilamentous state. The surface of the fiber structure is observed by TEM or SEM and one fiber is selected from an image enlarged by magnification of 1,000 times or more. It is considered that, when the fiber diameter of the fiber is less than 2 μm, the length of the fiber is 20 μm or more and, when the fiber diameter is 2 μm or more, the length is at least 10 times the fiber diameter. When the fiber is not continuously contacted with another fiber, it is regarded that the fibers are dispersed in a monofilamentous state. In an embodiment of the present invention, when the fiber structure is seen in the cross-section taken in the thickness-wise direction of the fiber structure, it is important that the ultrafine fibers (B) are monodispersed between the usual fibers and/or fiber bundles (A). When these fine fibers are dispersed in a monofilamentous state, flexibility of the fiber is exhibited and also structural uniformity of the fiber structure is improved. The proportion of these monodispersed fibers is preferably large. Specifically, in the cross-section of the fiber structure, the ratio of the fibers monodispersed between the fibers and/or fiber bundles (A) to the fibers which are not monodispersed is preferably 10:1 or more, and more preferably 50:1 or more.

When the fiber structure is seen in the cross-section taken in the thickness-wise direction of the fiber structure, when the proportion of a cross-sectional area of the single fiber or fiber bundle (A) based on a cross-sectional area of the fiber structure is too small, tenacity and form stability of the fiber structure become insufficient. The proportion is preferably 10% or more, more preferably 20% or more, and still more preferably 30% or more. In contrast, when the proportion is too large, flexibility and cushioning properties of the fiber structure become insufficient. The proportion is preferably 90% or less, more preferably 80% or less, and still more preferably 70% or less.

When the fiber structure is seen in the cross-section taken in the thickness-wise direction of the fiber structure, at least a part of the fibers dispersed in a monofilamentous state preferably form very small void spaces by bends or tangles, or bends and tangles (hereinafter may be referred to as bends and/or tangles). These void spaces can impart moderate cushioning properties to the fiber structure in embodiments of the present invention and, when the fiber structure is used as a polishing cloth, concentration of a polishing pressure against a specific position is suppressed and thus scratches can be reduced. Among the fibers (B), the proportion of the bent and/or tangled fibers is measured by the following procedure. That is, the cross-section of the fiber structure is observed by a transmission electron microscope (TEM) or a scanning electron microscope (SEM) and then the proportion of the number of the bent and/or tangled single fibers among 100 single fibers selected at random from the single fibers (B) is determined. The proportion of the bent and/or tangled fibers is preferably 20% or more, more preferably 40% or more, and still more preferably 60% or more, based on the entire fibers (B).

The fiber bundle (A) as another component constituting the fiber structure of the present invention according to exemplary embodiments is preferably composed of single fibers having a number average fiber diameter of 1 μm or less. When it is a fiber bundle composed of these fine single fibers, tenacity and form stability of the fiber structure can be sufficiently improved. When a tangle is formed between fine fibers existing on the outermost surface of the fiber bundle (A) and the ultrafine fibers (B) dispersed in a monofilamentous state, which exist between the fiber bundles (A), the fiber bundle (A) and the fibers (B) dispersed in a monofilamentous state are integrated. This integration has the effects of improving tenacity and form stability of the fiber structure. The fibers constituting the fiber bundle (A) and the fibers (B) dispersed in a monofilamentous state are preferably fibers composed of the same material since the both are easily integrated.

The void spaces to be formed by bends and/or tangles of the single fibers will be described. In the fiber structure, the void spaces generally exist. The void spaces can be classified into the following two kinds. One kind is clearance between the fibers formed since the fibers cannot be tightly adhered, completely, and can be formed along the longitudinal direction of the fiber while being surrounded by the cross-sections of 3 or more fibers. In addition, there are void spaces in which one single fiber forms a loop, or void spaces surrounded by an intersection of a plurality of fibers, which are referred to as the void spaces formed by bends and/or tangles of the single fibers. The method for distinguishing the above two kinds is as follows.

That is, when the cross-section of the fiber structure is observed by enlarging using SEM, or the like, a fiber whose cross-section can be observed and a fiber whose cross-section cannot be observed exist. The void spaces to be formed by bends and/or tangles of the single fibers refer to void spaces surrounded only by the later “whose cross-section cannot be observed”. The void spaces surrounded by the fiber whose cross-section cannot be observed and the fiber whose cross-section can be observed are not regarded as void spaces formed by bends and/or tangles of the single fibers since the objective effects imparting resilience of the fiber structure are insufficient.

In the fiber structure of an embodiment of the present invention, thin single fibers (B) exist between comparatively thick single fibers or fiber bundles (A). As a result, the fiber structure is a structure in which large void spaces scarcely exist compared with a fiber structure used as a conventional polishing cloth, but a lot of very small void spaces exist. Therefore, when the fiber structure is used as a polishing cloth, abrasive grains do not move in the fiber structure and remain on the surface of the fiber structure, and thus polishing can be conducted efficiently and uniformly. Such effects can be exerted by coexistence of ultrafine fibers dispersed in a monofilamentous state so as to fill a space between the usual fibers or fiber bundles in the fiber structure of embodiments of the present invention. By the way, polishing is usually conducted whole supplying a slurry in which abrasive grains are dispersed in a liquid such as water. In that case, when the liquid contained in the slurry has low permeability to the polishing cloth, the layer of a filmy liquid is formed on the surface of the polishing cloth, and thus the polishing cloth is less likely to contact with articles to be polished and efficiency of polishing may drastically decrease. However, in an embodiment of the present invention, the liquid in the slurry can be absorbed and discharged by the above very small void spaces and decrease of polishing efficiency can be prevented. By the existence of these void spaces, flexibility of the fiber structure, particularly cushioning properties in a thickness direction are improved. When the fiber structure is used as a polishing cloth, polishing with excellent smoothness and less scratches can be conducted.

It is preferred that at least one surface of the fiber structure of an embodiment of the present invention is covered with the ultrafine fibers (B).

A state in which the surface of the fiber structure is covered with ultrafine fibers (B) is determined by the following method. First, any position of the surface of the fiber structure is observed by TEM or SEM and a single fiber diameter of 30 fibers sampled at random is measured by using image processing software or directly measuring it on a printed photograph, and then it is confirmed that the fiber diameter is 1 μm or less. Next, the surface of the fiber structure is observed by SEM or an optical microscope under magnification of 50 times and it is confirmed that void spaces do not substantially exist on the surface. The expression “void spaces do not substantially exist on the surface” as used herein refers to the fact that 10 or less void spaces in a size of 10 μm² or more exist in a region of 2 mm square by observing under magnification of 50 times.

In an embodiment of the present invention, the fibers (B) with which the surface is covered are preferably dispersed in a monofilamentous state. Definition of the fibers dispersed in a monofilamentous state is as defined above.

The fiber structure of an embodiment of the present invention preferably has a surface light reflectance of 80% or more. Herein, high light reflectance means that the surface layer of the fiber structure is dense and also thin fibers does not form a bundle and is opened in a state closer to monodispersion. That is, when the fiber structure is used as a polishing cloth, since the structure has high light reflectance, abrasive grains do not move to an internal layer in the polishing cloth during polishing and remain on the surface and also abrasive grains are firmly held by fibers and less abrasive grains are agglomerated, and thus polishing with excellent smoothness can be conducted. When the light reflectance is less than 80%, since the degree of opening of the fiber is insufficient so as to hold the abrasive grains, the light reflectance is preferably 80% or more, and more preferably 90% or more. The light reflectance is a relative value assuming that the light reflectance of a standard white board defined in JIS P8152 (2005-Version) is 100% and there is no theoretical upper limit and also the light reflectance may exceed 100% depending on the fiber structure. When the fiber diameter is excessively decreased so as to enhance the light reflectance described hereinafter, the fibers are likely to be cut and polishing may become unstable. Therefore, the light reflectance is preferably 110% or less. The fiber structure having a high light reflectance can be achieved by making fibers of a surface layer to be very fine and allowing them to exit in a dense state. Herein, the light reflectance depends on the size of a specific surface area of the fibers on the surface of the fiber structure. That is, as the specific surface area increases, the reflectance becomes higher. In an embodiment of the present invention, the surface layer is substantially composed only of fibers and it is necessary that fine fibers are allowed to exist densely on the surface layer as if the surface layer is covered with the fibers without clearance in order to adjust the light reflectance to 80% or more. In order to allow to exit fiber densely as if the surface layer is covered with the fibers without clearance, all fibers are suitably arranged linearly. In such a state, since a force of fixing fibers each other does not exist, the form cannot be retained and thus it is impossible to obtain a fiber structure which can be used as a polishing cloth. Therefore, it is necessary to maintain the form through friction between the fibers by intersect weaving, knitting or tangling the fibers. As a distance between the intersections of fibers decreases, a distance between the fibers decreases and, as a result, the light reflectance can be increased. Since the distance between the intersections of fibers can be decreased as the fibers are easily bent, it is important that the fibers of the surface layer are made to be thin. In addition, it can be achieved by bending the fibers using a strong force. That is, for example, the light reflectance can be increased by a method of decreasing the diameter of the single fiber to 1 μm or less or forcibly bending fibers at random by a force of a high-pressure fluid flow to decrease a distance between tangles. A method of injecting a high-pressure fluid flow is a particularly preferably method since it has the effects of substantially thinning fibers by dispersing a bundle of fibers in a monofilamentous state.

The term “light reflectance in the present invention” as used herein refers to a value measured by the following method. That is, it is a reflectance determined by measuring an average reflectance of reflectances measured at 380 to 780 nm every 1 nm using a spectrophotometer is measured with respect to 3 samples collected from the surface layer portion at any position of the fiber structure, followed by simple averaging of the obtained values. A standard white board attached to an apparatus is used.

The fiber structure of embodiments of the present invention preferably has air permeability of 2 cc/cm²/sec or less.

As air permeability as used herein, a value measured according to a method (Frazier method) defined in JIS L-1096 (1999-Version) is used. Since the fiber structure of embodiments of the present invention is composed mainly of fibers and a lot of very small void spaces exist in the fiber structure, air permeability does not theoretically become zero. However, according to the method defined in JIS L-1096 (1999-Version), it may become a measuring limit of the apparatus or zero. Therefore, it is difficult to specify the lower limit of air permeability of the fiber structure and the lower limit is substantially zero.

When the air permeability is measured, the measurement is conducted after setting the fiber structure so that the surface of the fiber structure is a front. Lower air permeability means denseness of the fiber structure, small void spaces between fibers, particularly less large void spaces. That is, when the structure has low air permeability, abrasive grains remains on the surface without being moved to an internal layer of the fiber structure during polishing, and thus polishing can be efficiently conducted. As the polishing cloth, a polyurethane foam, a nonwoven fabric impregnated with polyurethane, a woven and knitted fabric, and the like, have hitherto been used. In the polishing cloth, it is considered that agglomerated abrasive grains and polishing wastes cannot be charged if the polishing cloth has low air permeability. Thus, there has been known a technique in which air permeability is enhanced by increasing the size of holes of a foam structure or void spaces between fibers (for example, Japanese Unexamined Patent Publication (Kokai) No. 2001-198797). However, there was not a conception that a high-performance polishing cloth is obtained by lowering air permeability. According to an embodiment of the present invention, it has been found that, by constituting a structure in which at least one surface is substantially covered with fibers, even if agglomerated abrasive grains and polishing wastes exist, an excessive load is dispersed because of high degree of freedom of the movement of fibers, and thus the occurrence of scratches can be suppressed unless large void spaces between the fibers exist.

It is more important that the fiber structure having low air permeability remarkably reduces void spaces between fibers of the surface layer and allows void spaces to exist in a dense state, and thus lowering air permeability of the surface layer of the fiber structure. Therefore, air permeability of the surface layer is preferably 2 cc/cm²/sec or less. The permeability of the surface layer as used herein is measured by the following procedure.

When the thickness of the fiber structure exceeds 0.3 mm, the thickness of the fiber structure is adjusted by slicing or grinding such as buffing and the sample is adjusted so as to adjust the thickness of the fiber structure at the surface layer side to 0.3 mm, and then a value measured according to a method (Frazier method) defined in JIS L-1096 (1999-Version) is used. In this case, it is necessary to prevent damage of the fiber structure, opening of holes and existence of very thin portion. When the thickness of the fiber structure is 0.3 mm or less, air permeability measured without slicing or grinding is taken as air permeability of the surface layer. As described hereinafter, when the fiber structure of an embodiment of the present invention is integrated with another fiber structure, plate-shaped body, film or the like, air permeability is measured after peeling or grinding the integrated another fiber structure, plate-shaped body, film or the like.

The method for production of a fiber structure of an embodiment of the present invention includes forming a fiber structure containing a polymer alloy fiber composed of a plurality of polymers each having a different solubility; removing at least one kind of a polymer among the plurality of polymers each having a different solubility of the polymer alloy fiber, thereby developing an ultrafine fiber having a fiber diameter of 10 to 1,000 nm to give a fiber bundle consisting of the assembled ultrafine fibers; and injecting a high-pressure fluid flow at 0.1 to 20 MPa into the fiber structure containing the fiber bundle consisting of the assembled ultrafine fibers.

The term “polymer” refers to a thermoplastic polymer such as polyester, polyamide or polyolefin; a thermocurable polymer such as a phenol resin; and a biopolymer such as DNA. Among these, a thermoplastic polymer is preferred in view of moldability. A polycondensation polymer such as polyester or polyamide is more preferably since it often has a high melting point. It is preferred that a melting point of a polymer formed into an ultrafine fiber after removing at least one of polymers each having a different solubility described hereinafter is 165° C. or higher since the ultrafine fiber has satisfactory heat resistance. For example, polylactic acid (PLA) has a melting point of 170° C., polyethylene terephthalate (PET) has a melting point of 255° C., and nylon 6 (N6) has a melting point of 220° C. The polymer may contain additives such as particles, flame retardant, antistatic agent and the like. The polymer may also be copolymerized with other components as long as properties of the polymer are not impaired.

Different solubility refers to different solubility in a certain solvent, and the solvent refers to water, an alkali solution, an acidic solution, an organic solvent, a supercritical fluid or the like. As long as an adverse influence is not exerted on other characteristics, it is preferred in view of stability of steps that a difference in solubility is larger since only a polymer having high solubility can be selectively removed. Hereinafter, a polymer having relatively high solubility may be referred to as a soluble polymer, whereas, a polymer having relatively low solubility may be referred to as a slightly soluble polymer.

Next, the polymer alloy fiber in embodiments of the present invention will be described. In the production method of an embodiment of the present invention, two or more kinds of polymers each having a different solubility are alloyed to give a polymer alloy melt, followed by spinning and further fiberization through solidification by cooling. If necessary, drawing and a heat treatment are conducted to obtain a polymer alloy fiber.

It is preferred that a soluble polymer is employed as a sea (matrix) and a slightly soluble polymer is employed as an island (domain) in the polymer alloy fiber as a precursor of the ultrafine fiber and also the island size is controlled since an island component is formed into the ultrafine fiber by removing a sea component of the polymer alloy fiber. Herein, the size of the island is determined by observing the cross-section of the polymer alloy fiber using a transmission electron microscope (TEM), followed by evaluation in terms of a diameter. Since the diameter of the ultrafine fiber nearly depends on the size of the island in the precursor, distribution of the island size is designed according to diameter distribution of the ultrafine fiber. Therefore, kneading of the polymer to be alloyed is very important and high kneading is preferably conducted by a kneading extruder or a static kneader in an embodiment of the present invention.

It is preferred to use the polymer alloy fiber obtained from the polymer alloy in the present invention according to exemplary embodiments. Since the thickness of the finally obtained ultrafine fiber becomes uniform by making a once alloyed polymer, followed by fiberization, and also the length of the ultrafine fiber is limited, it becomes possible to disperse easily and uniformly by the subsequent treatment of the high-pressure fluid flow. This cannot be easily achieved in the fiber obtained by a method of combining a plurality of polymer flows composed of a single kind of a polymer in a spinning machine or a spinneret, or a method of mixing tips composed of one kind of a polymer, followed by direct spinning.

Although a specific point during kneading depends on the polymer to be used in combination, when a kneading extruder is used, a twin-screw extrusion-kneader is preferably used for kneading. When a static kneader is used, the number of partitions is preferably set to 1,000,000 or more.

It is preferred that the size of the island is smaller since the finally obtained fiber is thin, and a combination of polymers is also important

In order to bring a shape of a cross-section of an ultrafine fiber into a circle shape as close as possible, the island polymer and the sea polymer are preferably incompatible. However, a simple combination of the incompatible polymers results in the difficulty in sufficiently ultrafine dispersion of the island polymers. For this reason, it is preferable to optimize compatibilities of the polymers to be combined, and one of indicators to do the optimization is a solubility parameter (SP value). Note that the SP value is a parameter reflecting cohesive force of a material, which is defined as (evaporation energy/molar volume)^{1/2}, and if polymers having close SP values are used, a polymer alloy having good compatibility may be obtained. The SP values of various polymers have been known, and are described in “Plastic Data Book” (co-edited by Asahi Kasei AMIDAS Co., Ltd./Plastic editorial department, page 189 and other pages). If a difference in SP value between two polymers is in a range of 1 to 9 (MJ/m³)^{1/2}, both rounding of the island domain due to becoming incompatible and an ultrafine dispersion are easily established, which is preferable. For example, the difference in SP value between N6 and PET is approximately 6 (MJ/m³)^{1/2}, which is a favorable example; however, in the case of N6 and Polyethylene (PE), the difference in SP value therebetween is approximately 11 (MJ/m³)^{1/2}, which is one of unfavorable example.

Also, if a difference in a melting point between polymers is 20° C. or lower, particularly at the time of kneading with the use of an extruding kneader, a difference in a molten state therebetween in the extruding kneader is unlikely to arise, resulting in high efficient kneading, which is preferable. Also, when a polymer that is likely to be thermally decomposed or thermally deteriorated is used as one component, kneading and spinning temperatures should be suppressed low, which has also an advantage. Note that an amorphous polymer has no melting point, and therefore glass transition temperature, Vicat softening temperature, or thermal deformation temperature is substituted for the melting point.

Further, melt viscosity is also important, and setting a melt viscosity of a polymer containing an island part to be lower than that of a polymer containing a sea part facilitates the deformation of the island polymer due to shear force, resulting in facilitating an ultrafine dispersion of the island polymer, which is preferable in terms of processing polymers into nanofibers. However, setting the viscosity of the island polymer to be too low causes the change of the polymer into a sea state to be facilitated, whereby a blend ratio to the whole fibers cannot be increased, and therefore it is preferable to set the viscosity of the island polymer to be 1/10 or more of that of the sea polymer.

A blending ratio of the island polymer is preferred from the viewpoint of increasing a basis weight of the fiber structure. For example, when the blending ratio of the island polymer is 10% by weight, the basis weight of the fiber structure is reduced to about 1/10 of the initial basis weight if the entire remaining 90% by weight of the sea polymer is removed, the fiber structure becomes a loose structure and thus dimensional stability drastically deteriorates. In order to improve dimensional stability of the fiber structure, the blending ratio of the island polymer is preferably 20% by weight or more, and more preferably 40% by weight or more, based on the entire polymer alloy fiber. Since it becomes difficult to form into an island when the blending ratio of the island polymer increases, the blending ratio of the island polymer is preferably set to 60% by weight or less, although it depends on melt viscosity balance with the sea polymer.

In the polymer alloy, since the island polymer is incompatible with the sea polymer, the island polymers are thermodynamically stable by mutually agglomerating the island polymers. However, the island polymer is forcibly dispersed ultrafinely, and thus there are a lot of very unstable polymer interfaces compared with a polymer blend having a conventional dispersion diameter in this polymer alloy. Therefore, when the polymer alloy is simply spun, because of a lot of very unstable polymer interfaces, there arises a “Barus phenomenon” in which the polymer flow largely swells immediately after discharging the polymer through the spinneret, and poor spinnability due to the unstabilized polymer alloy surface arises, resulting in excessive thick and thin evenness of the yarn and impossible spinning. In order to avoid these problems, a shear stress between a spinneret hole wall and a polymer upon discharge through the spinneret is preferably lowered. Herein, a shear stress between a spinneret hole wall and a polymer is calculated from the Hagen-Poiseuille formula (shear stress (dyne/cm²)=R×P/2L), wherein R is a radius of the spinneret discharge hole (cm), P is pressure loss at the spinneret discharge hole (dyne/cm²), L is a length of the spinneret discharge hole (cm), and P=(8LηQ/πR4), wherein η is polymer viscosity (poise), Q is a discharge amount (cm³/sec), and π is a circular constant. 1 dyne/cm² of a CGS unit system becomes 0.1 Pa in an SI unit system.

For example, in the conventional melt-spinning of a polyester, a shear stress between a spinneret hole wall and a polymer is 1 MPa or more, and is preferably set to 0.3 MPa or less when a polymer alloy in an embodiment of the present invention is melt-spun. For this reason, the spinneret hole diameter tends to be increased and the spinneret hole length tends to be decreased. When such an action is excessively conducted, measurability of the polymer at a spinneret hole deteriorates and thus unevenness of fineness and deterioration of spinnability occur. Therefore, it is preferred to use a spinneret having a polymer measuring portion at the upper portion of a discharge hole. Specifically, the polymer measuring portion is preferably a site in which a hole diameter is smaller than that of the discharge hole.

In view of sufficiently ensuring spinnability and spinning stability in melt-spinning, a spinneret face temperature is preferably set in a range of from a melting point of a sea polymer to 25° C. or higher. As described above, when the ultrafinely dispersed polymer alloy used in an embodiment of the present invention is spun, design of a spinning spinneret is important and cooling conditions of a yarn is also important. As described above, the polymer alloy is a very unstable molten fluid and is therefore preferably solidified by cooling immediately after discharging through a spinneret. Therefore, a distance from the spinneret to the beginning of cooling is preferably set in a range from 1 to 15 cm. Herein, the term “beginning of cooling” means the position where positive cooling of the yarn is initiated, and is replaced by a chimney upper end portion in an actual melt-spinning apparatus.

A spinning speed is not particularly limited, but is preferably a high speed in view of increasing a draft in the spinning process. A spinning draft of 100 or more is a preferable aspect in view of decreasing the obtained ultrafine fiber diameter.

The spun polymer alloy fiber is preferably subjected to drawing and a heat treatment, and yarn unevenness can be decreased by setting a preheating temperature upon drawing to a temperature of a glass transition temperature (Tg) or higher of the island polymer.

The form of the polymer alloy fiber can be appropriately selected from, in addition to a fiber having a round cross-section as a simple single component, a composite fiber, a crimped fiber, a modified cross-section fiber, a hollow fiber and a false twisted fiber composed of different or same kind of a polymer, and a spun yarn, a covering yarn and a hard twist yarn composed of short fibers according to the purposes.

Next, a fiber structure including the polymer alloy fiber is formed. The fiber structure is not particularly limited and examples thereof include a woven fabric, a knitted fabric, a nonwoven fabric and a composite thereof, and a composite with those other than fibers, such as a film and a polyurethane foam resin. Typical examples of the knitted fabric include, but are not limited to, a satin tricot knit fabric, a rib knit fabric, a half tricot knit fabric, a pile knit fabric, a plain knit fabric, an interlock knit fabric and the like. Typical examples of the woven fabric include, but are not limited to, a plain weave fabric, a twill woven fabric and a satin woven fabric of a single, double, triple or multiple structure; and a double velvet woven fabric, a single pile/plural pile double velvet woven fabric, an interlock velvet woven fabric, a chinchilla-like woven fabric and the like. The nonwoven fabric can be produced by employing a method in which short fiber made of a polymer alloy is formed and then a nonwoven fabric is obtained by card or paper making or a method in which a nonwoven fabric is directly formed from a polymer alloy using a melt-blow method or a spun-bond method.

If necessary, a resin or a chemical can be applied to the fiber structure and the surface can be processed by gigging or press, and also fibers can be cut by needle punching and fibers can be tangled by a high-pressure fluid flow. It is also possible to produce a composite from fiber structures by needle punching or a high-pressure fluid without using a binder.

According to an embodiment of the present invention, a fiber bundle containing assembled ultrafine fibers is obtained by eluting a readily soluble polymer as a sea polymer from the thus obtained fiber structure including polymer alloy fibers. Herein, the larger the number of ultrafine fibers obtained by eluting the sea polymer from the polymer alloy fiber, the better the degree of mixing the polymer in the polymer alloy fiber, and the shorter the length of the ultrafine fiber. Therefore, the fiber after treating with a high-pressure fluid flow is excellent in dispersibility. In view of reducing environmental burden, it is preferred to use, as a solvent for dissolving a readily soluble polymer from the polymer alloy fiber, an aqueous solution-based solvent. Specifically, it is preferred to use a neutral to alkali aqueous solution. The neutral to alkali aqueous solution as used herein is an aqueous solution having a pH of 6 to 14 and a chemical to be used is not particularly limited. For example, the chemical may be an aqueous solution containing organic or inorganic salts, which exhibits the pH in the above range, and examples of the chemical include alkali metal salts such as sodium hydroxide, potassium hydroxide, lithium hydroxide, sodium carbonate and sodium hydrogen carbonate; and alkaline earth metal salts such as calcium hydroxide and magnesium hydroxide. If necessary, amines such as triethanolamine, diethanolamine and monoethanolamine, reduction accelerators, carriers, and the like can also be used in combination. Among these, sodium hydroxide is preferable in view of cost and ease of handling. Furthermore, it is preferred that the sheet is subjected to a treatment with the above neutral to alkali aqueous solution and optionally neutralized or washed to remove the remained chemical or decomposing products, followed by drying.

Therefore, as the readily soluble polymer, alkali-hydrolyzed polymers such as polyester; and hot water-soluble polymers such as polyalkylene glycol, polyvinyl alcohol and derivatives thereof are preferably used.

By such a production method, there can be obtained a fiber bundle in which ultrafine fibers having a fiber length of several tens of micron meter, sometimes centimeter-order are assembled.

In an embodiment of the present invention, it is preferred that the diameter of the ultrafine fiber is 1 μm or less, and is more preferably from 10 nm to 1 μm. When the fiber diameter is less than 10 nm, tenacity and abrasion resistance become insufficient because of too low fiber tenacity, and thus it is impossible to use as a polishing cloth, a wiper or the like. In contrast, when the fiber diameter exceeds 1 μm, flexibility and high surface area as features of the ultrafine fiber cannot be obtained and the dispersion effects of the fiber due to a high-pressure fluid flow are insufficient, and thus the object of embodiments of the present invention cannot be achieved.

It is preferred that the fiber bundle containing assembled ultrafine fibers has a number average fiber diameter of 3 μm or more. The fiber bundle in which a number ratio of ultrafine fibers having a diameter of 10 to 500 nm constituting the fiber bundle is 60% or more is preferred since the fiber diameter has high uniformity and thin fibers do not coexist and thus a surface having high smoothness containing fibers dispersed highly can be obtained after treating with a high-pressure fluid flow treatment.

The diameter of the ultrafine fiber is determined by the following procedure. Using a TEM photograph of a fiber cross-section, an ultrafine fiber cross-sectional area is determined by image processing software and then a single fiber diameter is determined assuming that the ultrafine fiber has a circular cross-section.

The production method of an embodiment of the present invention includes injecting a high-pressure fluid flow into a fiber structure including an ultrafine fiber bundle. The expression “injecting a high-pressure fluid flow” as used herein means collision of a liquid under 0.1 MPa or more against the fiber structure, which aims at monodispersing and opening of the ultrafine fiber. The liquid used in such a treatment is preferably water in view of operability, cost, collision energy quantity and efficiency. The liquid also include an aqueous solution, a dispersion and an emulsion prepared by mixing water with other components, for example, an organic solvent, an alkali, an acid, a dye, a resin, a lubricant, a softening agent, silicone, urethane and the like. A pressure of the high-pressure fluid is set in a range from 0.1 to 20 MPa, and preferably from 1 to 10 MPa. When the pressure is low, the dispersion effects of the ultrafine fiber are not sufficient. In contrast, when the pressure is too high, dropping-off of the ultrafine fiber occurs during the treatment and the fiber structure is broken, which is not preferred. The term “pressure of the fluid flow” as used herein refers to a pressure of the fluid inside a nozzle. A diameter of the nozzle for injecting a high-pressure fluid is from about 50 to 700 μm, and preferably from about 100 to 500 μm, and a distance between nozzles is preferably 1 mm or less. The injection time and number can be optionally selected. When the treatment is conducted a plurality of times, the pressure and treating rate can also vary every treatment.

Prior to injecting of the high-pressure fluid flow, the fiber structure may be subjected to a water dipping treatment. In order to improve quality of the surface, a method of relatively transferring a nozzle head and a nonwoven fabric or a method of conducting a water spraying treatment by inserting a wire gauze into space between nonwoven fabric and a nozzle after interlacing can be used. In such a treatment, it is preferred that a high-pressure fluid flow is uniformly injected on the surface of the fiber structure. Specifically, a cover factor obtained by dividing an area of the surface of the fiber structure, on which a water flow is applied, by the entire surface area of the fiber structure is preferably 80% or more. The cover factor can be increased by fluctuating a nozzle head at right angles in a running direction of a sheet, arranging a nozzle on a staggered form or treating a plurality of times using a nozzle having a different pattern. The cover factor can be calculated, for example, by the following methods.

### (1) In Case of Using a Nozzle Having Each Inline Array of Circular Holes in a Fixed State

The cover factor can be determined by the following equation 1:

$$\frac{R}{P} \times 100 ( \% ) \qquad [ Equation 1 ]$$

wherein R denotes a diameter of a circular hole and P denote a pitch (center distance) of a circular hole.

### (2) In Case of Using a Nozzle Having Each Inline Array of Circular Holes in a Fluctuated State

The cover factor can be determined by the following equation 2:

$$\frac{R}{P} \times \frac{1}{cos θ} \times 100 ( \% ) \qquad [ Equation 2 ]$$

wherein R denotes a diameter of a circular hole, P denote a pitch (center distance) of a circular hole and θ denotes an angle showing a trace of a water flow from a circular hole to a running direction of a sheet.

The above formula can be determined from the following equation 3:

$$\frac{R}{P} \times \sqrt{1 + \frac{4 {L}^{2} {C}^{2}}{{S}^{2}}} \times 100 ( \% ) \qquad [ Equation 3 ]$$

wherein L (mm) denotes a width of fluctuation, S (mm/sec) denotes a running speed of a sheet and C (Hz) denotes a frequency of fluctuation.

### (3) In Case of Conducting a Treatment a Plurality of Times

When a treatment is conducted a plurality of times using one array of nozzles, a cover factor is determined every treatment by the above method and the sum of the obtained cover factors is taken as a cover factor of the entire treatment. When pores exist in a plurality of arrays such as 2 arrays, 3 arrays and the like in one nozzle, a cover factor is determined regarding each array as one treatment and the sum of the obtained cover factors is taken as a cover factor of the entire treatment.

As a fluid temperature of a high-pressure fluid, any temperature in a range from a normal temperature to 100° C. can be applied. It is preferred that the fiber structure is continuously treated by placing on a drum with a mesh wire gauze or an opening and running using a conveying system such as a belt conveyor. The nozzle can also be fluctuated in a length or width direction of a knitted and woven fabric, and not only one surface but also both surfaces can be treated.

The technique described in Japanese Unexamined Patent Publication (Kokai) No. 60-39439 aims at tangling ultrafine fibers included in a woven fabric and therefore describes that it is not preferred that a pressure of a fluid is too high because breakage of fibers occurs. On the other hand, an object of the present invention according to exemplary embodiments is to monodisperse ultrafine fibers constituting a fiber bundle thereby uniformly distributing the ultrafine fibers on the surface of a fiber structure, and the fiber bundle containing the ultrafine fibers is substantially cut. Thus, an embodiment of the present invention is basically different from the above technique in an idea. According to the method of an embodiment of the present invention, a fiber structure having a surface covered with ultrafine fiber in a film state is obtained. When the fiber structure is used as a polishing cloth, smoothness of a substrate after polishing is improved because of excellent smoothness and uniformity of the surface. Since a substantial surface area of the fibers increases, wiping properties are remarkably improved when the fiber structure is used as a wiping cloth.

Japanese Unexamined Patent Publication (Kokai) No. 2005-23435 and an embodiment of the present invention are identical in that ultrafine fibers constituting the fabric are treated with a high-pressure water flow. However, as is apparent from the production method, the ultrafine fiber of the technique is a continuous yarn and the technique aims at properly increasing a fiber space. In contrast, an embodiment of the present invention aims at monodispersing ultrafine fibers thereby uniformly distributing the ultrafine fibers on the surface of a fiber structure. Thus, the both are quite different in the objective effects and a form of a fiber structure obtained by a treatment.

Furthermore, Japanese Unexamined Patent Publication (Kokai) No. 2004-256983 discloses an artificial leather formed from a nanofiber assembly and describes that a high-pressure water flow treatment may be conducted. However, such a high-pressure water flow treatment aims at tangling fibers constituting a fiber structure thereby increasing tenacity of the fiber structure, and orienting the fibers in the thickness-wise direction of the fiber structure thereby improving texture and also an tangling treatment is conducted prior to removal of one component of a polymer alloy fiber thereby exhibiting ultrafine fibers. Thus, the technique of the publication and that of the present invention according to exemplary embodiments are quite different in an idea and effects.

It is one of the preferred aspects in an embodiment of the present invention to conduct a heat treatment at a temperature of 100° C. or higher after injection of the high-pressure fluid flow. Regarding the fiber structure obtained by an embodiment of the present invention, a fiber bundle containing agglomerated ultrafine fibers is monodispersed by kinetic energy of a fluid, sometimes by swelling effects, and thus shape retention of the fiber structure deteriorates. The monodispersed ultrafine fibers can not be used sometimes according to the applications such as a wiper used in a clean room since dropping-off of the monodispersed ultrafine fibers is likely to occur. In that case, it is possible to improve shape retention of the fiber structure and to prevent dropping-off of fibers by partially fusing the monodisperse ultrafine fiber by the above heat treatment. A temperature of such a heat treatment is 100° C. or higher, preferably 120° C. or higher, and still more preferably 130° C. or higher. When the polymer constituting the fiber is melted, flexibility as a feature of ultrafine fibers deteriorates and scratches are made when the fiber structure is used as a polishing cloth or a wiping cloth. Therefore, it is preferred to treat at a melting point or lower of the polymer, and preferably a temperature which is lower than the melting point by 10° C. or more.

Such a heat treatment method is not particularly limited and can be appropriately selected from methods exemplified below. For example, there can be employed a method of exposing to high-temperature air, a method of irradiating with infrared rays, a method of exposing to high-temperature steam, and a method of dipping in hot water. Examples of the apparatus used in the heat treatment include a continuous dryer of transferring articles to be treated using a conveyer, a batch-type dryer such as tumbler, a steamer, a jet dyeing machine and the like.

Since a fiber structure containing a plurality of layers is one of preferred aspects according to the applications, it is also preferred to laminate a plurality of fiber structures. The term “fiber structure containing a plurality of layers” as used herein includes that the above surface layer and one or more layers containing fibers are included in the fiber structure. By including the plurality of layers, while having a feature of the surface layer in which ultrafine fibers are monodispersed, characteristics such as tenacity, elasticity, compression characteristics and water permeability of the entire fiber structure can be adjusted in a desired range. Specifically, cushioning properties can be imparted by providing a lower layer of the above surface layer with a nonwoven fabric layer containing thicker fibers. By combining with a woven fabric, tenacity is improved and thus form stability can be improved. When the surface layer contacted with a substrate is selectively allowed to maintain moisture by forming a surface layer using a hydrophilic polymer and forming a lower layer using a hydrophobic polymer, efficiency of polishing or cleaning can be improved.

The polymer constituting the fibers included in the surface layer and other layers is not particularly limited as long as it is a polymer having a fiber-forming ability and various polymers can be selected according to the purposes and applications. For example, when the fiber structure of an embodiment of the present invention is used as a polishing cloth, the kind of the fiber used as the polishing cloth can be changed by the material of the substrate to be polished or abrasive grains to be used. In view of abrasion resistance, retentiveness and dispersibility of abrasive grains, and surface smoothness, the polymer constituting the fiber is preferably polyamide. Examples of the polyamide include polymers having an amide bond, such as nylon 6, nylon 66, nylon 610, and nylon 12. On the other hand, When a substrate material is hard, the polymer constituting the fiber is preferably polyester. As a polishing cloth for texturing a recording disk composed of a glass substrate, high grinding force is required for directly grinding glass. The polyester is not particularly limited as long as it is a polymer synthesized from dicarboxylic acid or an ester-forming derivative and diol or an ester-forming derivative thereof and can be used as the fiber. Specific examples thereof include polyethylene terephthalate, polytrimethylene terephthalate, polytetramethylene terephthalate, polycyclohexylenedimethylene terephthalate, polyethylene-2,6-naphthalene dicarboxylate, polyethylene-1,2-bis(2-chlorophenoxy)ethane-4,4′-dicarboxylate and the like. In an embodiment of the present invention, a polyethylene terephthalate or a polyester copolymer containing mainly an ethylene terephthalate unit, which is used most usually, is preferably used.

The method of laminating a plurality of fiber structures is not particularly limited and methods exemplified below can be employed. For example, a method in which fiber structures are integrated by tangling of fibers by needle punching or a high-pressure fluid flow in a state where a plurality of fiber structures are laminated can be employed. Such a method is preferred since it does not require the use of a binder and therefore air permeability, liquid permeability and flexibility of the fiber structure do not deteriorate. When such a method is employed, since it is desired that fibers constituting the fiber structure can freely move to some extent, it can be preferably employed when the fiber structure is a short fiber woven and knitted fabric, a short fiber nonwoven fabric, a long fiber woven and knitted fabric using a composite yarn in which a difference in yarn length exists, or a long-fiber nonwoven fabric partially cut by needle punching. It is also possible to mutually integrate fiber structures through an adhesive. The adhesive is not particularly limited and general acrylic-based, polyurethane-based, polyamide-based, polyester-based and vinyl-based adhesives can be used. In the application of the adhesive, a method of applying an adhesive using a gravure roll, a method of applying using a spray or a method of laminating sheets containing an adhesive is employed and fiber structures can be integrated by appropriately applying pressure or heat.

In the production method of an embodiment of the present invention, a polymeric elastomer such as urethane may be applied as long as the effects of the obtained fiber structure are not impaired. As the polymeric elastomer, for example, there can be used various polymeric elastomers, which enable the objective texture, physical properties and quality, after appropriate selection and examples thereof include polyurethane, acryl, styrene-butadiene and the like. Among these, polyurethane is preferably used in view of flexibility. The method for producing polyurethane is not particularly limited and can be produced by appropriately reacting polymerpolyol, diisocyanate and a chain extender. Either a solvent system or a water dispersion system may be used, and a water dispersion system is preferred in view of working environment.

When a polymeric elastomer is impregnated, sufficient attention must be paid so that the polymeric elastomer is not substantially exposed to a surface. From such a point of view, the content of the polymeric elastomer is preferably 10% or less, more preferably 5% or less, and still more preferably 2% or less, based on the entire weight. When a solvent-based polymeric elastomer is used, a wet coagulation method is employed and, when a water-dispersible polymeric elastomer is used, a heat-sensitive coagulation method is used. That is, migration of the polymeric elastomer onto a surface is preferably suppressed.

However, in view of the fact that the fiber structure obtained by an embodiment of the present invention has clear feature and the feature is more excellent compared with the prior art, it is preferred that the fiber does not substantially contain a polymeric elastomer and is mainly composed of a fiber material. Furthermore, it is also preferred that the fiber material is substantially composed of fibers of a non-elastic polymer.

For the purpose of improving flexibility of the fiber structure, a crumpling treatment can be conducted. The crumpling treatment can be generally conducted by an apparatus such as a texturing machine or a dying machine and, specifically, a jet dyeing machine, a winch dying machine, a jiger dying machine, a tumbler and a relaxing machine can be used. In an embodiment of the present invention, the crumpling treatment is preferably conducted after conducting a high-pressure fluid flow treatment. When the crumpling treatment is conducted prior to the high-pressure fluid flow treatment, the effects drastically deteriorate according to the high-pressure fluid flow treatment, which is not preferred.

Furthermore, when the thickness is reduced by 0.1 to 0.8 time through calendaring at a temperature of 100 to 250° C. after conducting the high-pressure fluid flow treatment, fiber apparent density can be increased. It is also preferred because surface smoothness is excellent and surface roughness can be easily adjusted within the scope of the present invention according to exemplary embodiments. When the thickness is reduced to less than 0.1 time, texture is too hard, and it is not preferred. Although the thickness may be reduced to more than 0.8 time, the effects of compression are lowered. Furthermore, when the fiber structure is treated at a temperature of lower than 100° C., the effects of compression are lowered, and it is not preferred. When the fiber structure is treated at a temperature of higher than 250° C., scratches are likely to be formed by fusion of fibers, which is not preferred. When compression is conducted prior to the high-pressure fluid flow treatment, tangling by the high-pressure fluid flow treatment does not easily proceed, which is not preferred.

Furthermore, it is preferred to form unevenness or grooves on the surface of the fiber structure by embossing when the fiber structure of an embodiment of the present invention is used as a polishing cloth. The fiber structure having such a surface is useful to improve uniformity of polishing or to reduce scratches since abrasive grains and polishing wastes are easily supplied and discharged. The term “embossing” used herein refers to processing of forming an irregular pattern on a fabric by passing the fabric through a metal roller sculpted with an irregular pattern and a resilient roller made of a compressed cotton, a compressed paper or a rubber while maintaining at a given temperature. Describing about an embossed pattern, the pattern is not specified and a sculpted roller with a satin pattern, a lattice pattern, a check pattern, a sheep pattern, a kangaroo pattern or the like is preferably used.

In an embodiment of the present invention, an area of a concave surface preferably accounts for 4% to 80% (convex surface area is from 96% to 20%), and more preferably 10% or more and 45% or less, of the area of the entire embossed fiber structure. Regarding a temperature of a heat roller, optimum conditions may be selected according to the processing speed, pressing, thickness of a fiber structure, and the number of embossing. Regarding preferable condition range in the pressing, a processing temperature is preferably no more than a temperature which is 10° C. lower than a melting point of the ultrafine fiber in view of processing stability. A linear pressure is from 5 to 400 kg/cm, a processing speed is from 0.5 to 20 m/min and a passing number is from 1 to 10 times.

When the linear pressure is 400 kg/cm or more and/or the processing speed is less than 0.5 m/min, breakage occurs as a result of an excessive pressure, which is not preferred. In contrast, when the linear pressure is less than 5 kg/cm and the processing speed exceeds 10 m/min, pressing effects become insufficient, which is not preferred.

The fiber structure obtained by an embodiment of the present invention can be preferably used for applications in which flexibility and large surface area as features of ultrafine fibers are utilized since ultrafine fibers do not form a bundle and exist in an opened state. For example, when the fiber structure is used as a wiping cloth such as eyeglass wiper, the fiber structure is not only excellent in wiping properties, but also makes no scratch on the object. Furthermore, when the fiber structure is used as a polishing cloth used in the manufacturing process of hard disks, silicon wafers, integrated circuit boards, precision instruments, optical components and the like, since high effects of retaining abrasive grains are exerted, agglomeration of abrasive grains is less likely to occur. Also, because of high smoothness of the fiber structure, surface smoothness of articles to be polished can also be extremely improved. The fiber structure can also be used as artificial blood vessels and cell culture substrates by utilizing biocompatibility.

### EXAMPLES

Embodiments of the present invention will be hereinafter described in detail by way of Examples. As measuring methods in Examples, the following methods were used.

### A. Melt Viscosity of Polymer

A melt viscosity of a polymer was measured by Capillograph 1B manufactured by Toyo Seiki Seisaku-sho, LTD. The residence time from charge of samples to the beginning of the measurement of the polymer was set to 10 minutes.

### B. Melting Point

Using DSC-7 manufactured by The Perkin Elmer Corporation, a peak top temperature showing melting of a polymer at 2nd run was taken as a melting point. A temperature increase rate was set to 16° C./min and an amount of a sample was set to 10 mg.

### C. Observation of Fiber Cross-Section by TEM

An ultra-thin piece was cut in a cross-sectional direction of a fiber and then a fiber cross-section was observed by a transmission electron microscope (TEM) shown below. Nylon was metallic stained with phosphotungstic acid.

TEM apparatus: Model H-7100FA, manufactured by Hitachi, Ltd.

### D. SEM Observation

A fiber structure was vapor-deposited with a platinum-palladium alloy and then a fiber cross-section was observed by a scanning electron microscope (SEM) shown below. When a cross-section of the fiber structure is observed, the fiber structure was frozen by dipping in liquid nitrogen for 10 minutes, taken out immediately and cut in a thickness direction by a blade of a razor, and then vapor deposition and SEM observation were conducted by the above method.

SEM apparatus: Model S-4000, manufactured by Hitachi, Ltd.

### E. Fiber Diameter and Number Average Fiber Diameter of Single Fiber and Fiber Bundle

Using TEM in the above item C and SEM of the above item D, at least 300 single fibers were observed under magnification which enables observation in one visual field. Using image processing software, each diameter of 300 single fibers or fiber bundles sampled at random in the same visual field was measured up to a place of 0.01 μm from the observed photograph. A number average fiber diameter was calculated by determining a simple average of the obtained value up to a place of 0.01 μm.

### F. Air Permeability

The measurement was conducted according to the method (Frazier method) defined in JIS L-1096 (1999-Version).

### G. Light Reflectance

A sample of 5 cm square was prepared and a reflectance at 380 to 780 nm was measured in a state where a φ60 integrating sphere 130-063 (manufactured by Hitachi, Ltd.) and a 10° sloped spacer are attached to a spectrophotometer U-3410 (manufactured by Hitachi, Ltd.). The measurement was conducted using 3 samples and a reflectance was determined by simple averaging of the values at 560 nm. A standard white board attached to the apparatus (manufactured by Hitachi, Ltd.) was used.

### H. Polishing Characteristics

A fiber structure (sheet) was slitted to give a tape having a width of 38 mm, followed by polishing under the following conditions. That is, an aluminum substrate was subjected to a Ni—P plating treatment and then polished. Using a disk having a controlled average surface roughness of 0.2 nm, an isolated abrasive grain slurry containing diamond crystals having a primary particle diameter of 1 to 10 nm was dropped on the surface of a polishing cloth in a feed amount of 10 ml/min, and then polishing was conducted under the conditions of a disk rotational speed of 300 rpm, a pressure of the tape against the disk of 98.1 kPa and a tape running speed of 6 cm/min for 30 seconds (texturing).

In accordance with JIS B0601 (2001-Version), surface roughness was measured at any 10 points of the surface of a disk substrate sample after texturing using a TMS-2000 surface roughness analyzer manufactured by Schmitt Measurement Systems, Inc., and then substrate surface roughness was calculated by averaging the measured values at 10 points. A lower numerical value shows higher performances. With respect to the entire region of both surfaces of 5 substrates after texturing, namely, 10 surfaces in total as measuring objects, using Candela 5100 optical surface analyzer, grooves having a depth 3 nm or more were regarded as scratched. The number of scratches was measured and the evaluation was conducted by an average of the measured values of 10 surfaces. A lower numerical value shows higher performances.

### Example 1

### Production of Nonwoven Fabric

Nylon 6 (hereinafter referred to as N6) having melt viscosity of 212 Pa·s (262° C., shear rate: 121.6 sec⁻¹) and a melting point of 220° C. and poly-L-lactic acid (optical purity: 99.5% or more) having a weight average molecular weight of 120,000, melt viscosity of 30 Pa·s (240° C., 2432 sec⁻¹) and a melting point of 170° C. were used and the content of N6 was adjusted to 45% by weight, and then the mixture was melt-kneaded at a kneading temperature of 220° C. to obtain polymer alloy tips.

The weight average molecular weight of poly-L-lactic acid was determined by the following procedure. A chloroform solution of a sample was mixed with THF (tetrahydrofuran) to obtain a measuring solution. The concentration of polylactic acid was adjusted to 0.4% by weight. Using gel permeation chromatography (GPC) Waters 2690 manufactured by Waters Corporation, a polystyrene equivalent weight average molecular weight was determined by measuring at 25° C. The melt viscosity of poly-L-lactic acid was 86 Pa·s at 215° C. and 1216 sec⁻¹.

The thus obtained polymer alloy tips were extrude through fine pores at a spinning temperature of 240° C., spun through an ejector at a spinning speed of 4,500 m/min, collected on a moving net conveyor and then heat-fused under the conditions of a temperature of 80° C. and a linear pressure of 20 kg/cm using an embossing roll at a contact bonding ratio of 16% to obtain a long-fiber nonwoven fabric having a single fiber fineness of 2.0 dtex and a basis weight of 150 g/m².

### Production of Composite Sheet

To a nonwoven fabric containing the obtained polymer alloy fibers, an oil solution (SM7060: manufactured by Dow Corning Toray Silicone Co., Ltd.) was applied in an amount of 2% by weight based on the weight of the fibers, followed by needle punching at 1000 needles/cm² to obtain a nonwoven fabric containing polymer alloy fibers having a basis weight of 120 g/m² and a density of 0.09 g/cm³. In a state where a nonwoven fabric and a needle-punched nonwoven fabric containing polyester short fibers having a single fiber fineness of 0.1 dtex are laminated, a water flow under a pressure of 12 MPa was injected through a nozzle with 0.1 mmφ circular holes at a distance 0.6 mm, thereby integrating two kinds of the above nonwoven fabrics to obtain a composite sheet.

The treatment was conducted at a treating rate of 1 m/min while fluctuating the nozzle in a width direction of a fiber structure at amplitude of 4 mm and 18.6 Hz. The direction of the water flow injected through the nozzle was adjusted so that it meets around right angles to the sheet. In this case, a cover factor was 150%. By dipping the obtained fiber structure in an aqueous 3% by weight sodium hydroxide solution (95° C., bath ratio of 1:100) for 2 hours, 99% or more of poly-L-lactic acid as a sea polymer in the polymer alloy fiber was removed by hydrolysis. The thus obtained sheet is referred to as a composite sheet. The composite sheet I was observed by SEM. As a result, a fiber bundle in which 500 or more ultrafine fibers are assembled is formed. The fibers are drawn out from the composite sheet and a fiber cross-section was observed by TEM, and thus a single fiber diameter (number average fiber diameter) of the fibers was determined. As a result, it was 110 nm.

Then, the water flow was injected again under the above conditions thereby dispersing some fibers of fibers constituting the fiber bundle in a monofilamentous state to obtain a fiber structure. The thus obtained sheet is referred to as a composite sheet II. The obtained composite sheet II was observed by SEM. As a result, the entire surface of the fiber structure is covered with fibers (B) having a number average fiber diameter of 110 nm in a monofilamentous state without clearance. In the cross-section, the fibers (B) having a fiber diameter of 1 μm or less (number average fiber diameter: 110 nm) dispersed in a monofilamentous state form fine void spaces due to tangles or bends and also exist together with a fiber bundle (A) having a fiber bundle diameter of 3 μm or more (number average fiber bundle diameter: 8.3 μm).

The obtained fiber structure had a thickness of 0.5 mm. The fiber structure had air permeability of 0.5 cc/cm²/sec. The fiber structure had a light reflectance of 96%.

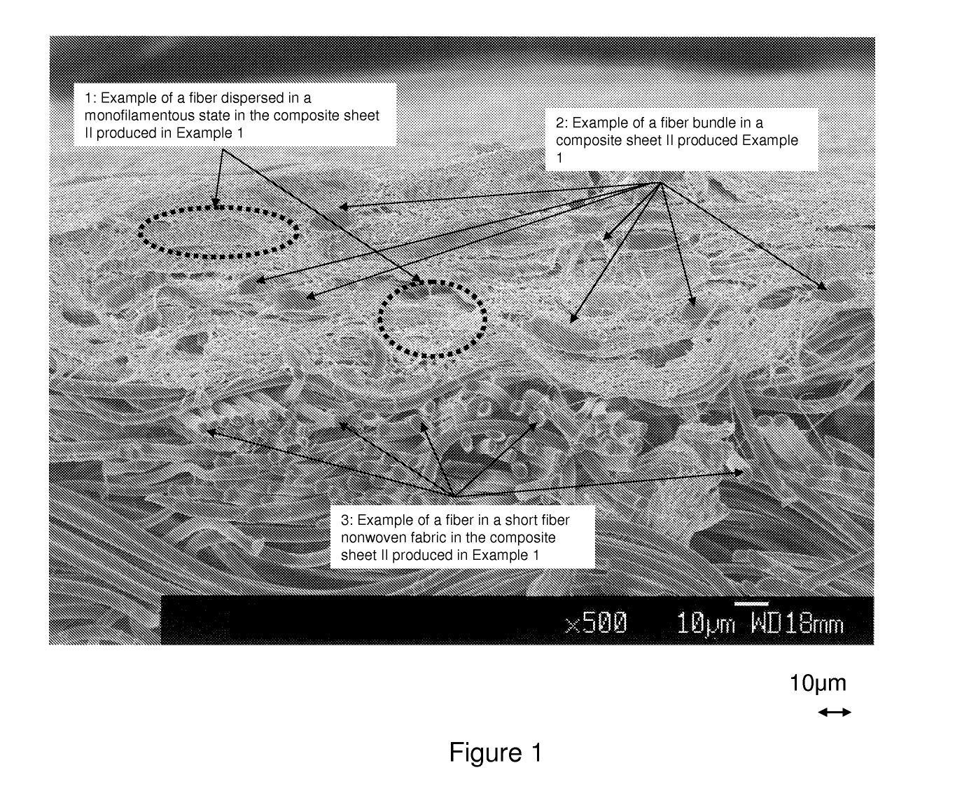

The obtained composite sheet was slitted to give a tape having a width of 38 mm and polishing characteristics were evaluated. As a result, the disk after polishing showed surface roughness of 0.30 nm and the number of scratches of 1.1 and is extremely excellent in smoothness and low scratch properties. In FIG. 1, a SEM photograph of the surface of the fiber structure produced in Example 1 is shown.

### Example 2

Two kinds of nonwoven fabrics were integrated by conducting a treatment of injecting a water flow to the composite sheet I obtained in Example 1 under the same conditions as in Example 1, except that the pressure of the water flow was adjusted to 1 MPa. The thus obtained sheet is referred to as a composite sheet III. The composite sheet III was observed by SEM. As a result, the entire surface of the fiber structure is covered with fibers (B) having a number average fiber diameter of 110 nm in a monofilamentous state without clearance. In the cross-section, the fibers (B) having a fiber diameter of 1 μm or less (number average fiber diameter: 110 nm) dispersed in a monofilamentous state form fine void spaces due to tangles or bends and also exist together with a fiber bundle (A) having a fiber bundle diameter 15.5 μm).

The obtained composite sheet was slitted to give a tape having a width of 38 mm and polishing characteristics were evaluated. The composite sheet had a thickness of 0.6 mm. The fiber structure had air permeability of 0 cc/cm²/sec (measurement limit or less). The sheet showed a reflectance of 97%.

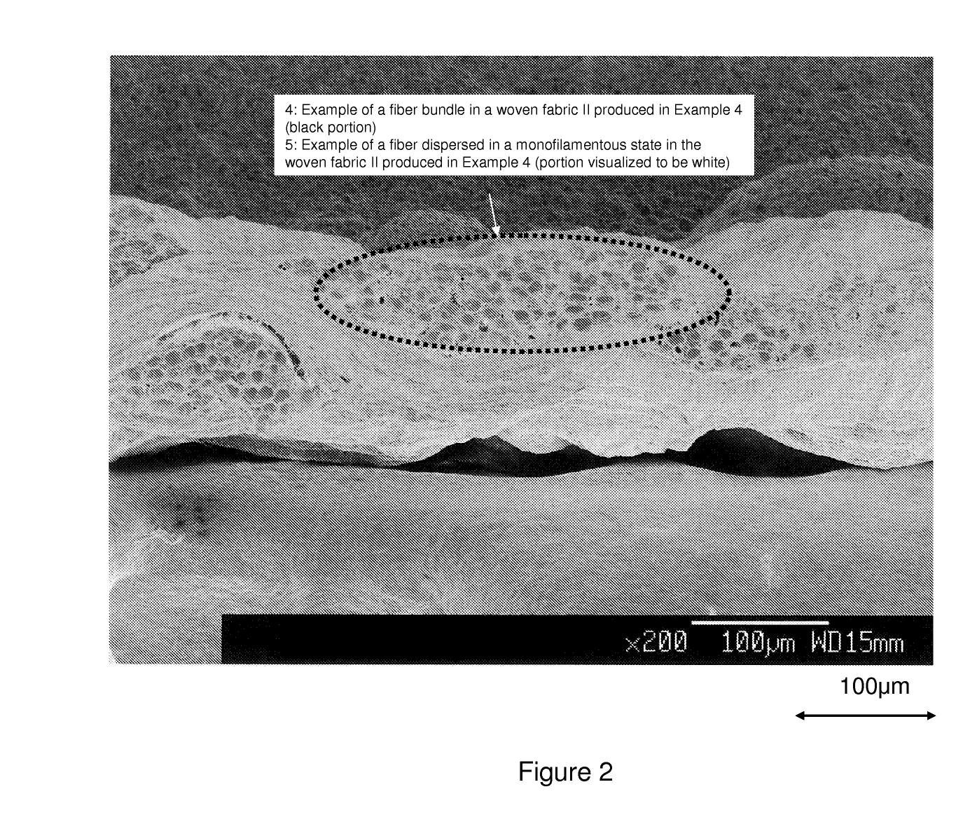

The disk was polished under the same conditions as in Example 1. As a result, the disk after polishing showed surface roughness of 0.26 nm and the number of scratches of 0.9 and is extremely excellent in smoothness and low scratch properties. In FIG. 2, a SEM photograph of the surface of the fiber structure produced in Example 1 is shown.

### Example 3

The fiber structure obtained in Example 1 was embossed to form random strip-shaped concave portions. The treating rate was 1.5 m/min and the temperature of a sculpted roll was 140° C. On the surface after embossing, stripe-shaped recesses having a depth of several micron meter which surround a region of about 500 μm were formed. Under the same conditions as in Example 1, the disk was polished. As a result, the disk after polishing showed surface roughness of 0.27 nm and the number of scratches of 1.2 and is extremely excellent in smoothness and low scratch properties. The polishing rate was high such as 4.6 mg/min.

### Comparative Example 1

A long fiber nonwoven fabric was produced in the same manner as in Example 1, except that only N6 was used in place of the polymer alloy tips in the production of the long-fiber nonwoven fabric in Example 1. Then, in the same manner as in Example 1, the long-fiber nonwoven fabric was integrated with a polyester single fiber needle-punched nonwoven fabric. Then, dipping in an aqueous sodium hydroxide solution was not conducted. Furthermore, the treatment of injecting a water flow was conducted under the same conditions as in Example 1.

The surface of the obtained fiber structure was observed by SEM and a fiber diameter of the fibers existing on the surface was measured. As a result, it was 15.0 μm. In the cross-section, although the same fibers as those on the surface existed, fine void spaces due to interlace or bending were not observed because of a large fiber diameter.

The obtained fiber structure had a thickness of 0.7 mm. The fiber structure had air permeability of 24 cc/cm²/sec. The fiber structure had a light reflectance of 67%. The disk was polished under the same conditions as in Example 1. As a result, the disk after polishing showed surface roughness of 0.42 nm and the number of scratches of 3.1 and is extremely inferior in smoothness and low scratch properties.

### Example 4

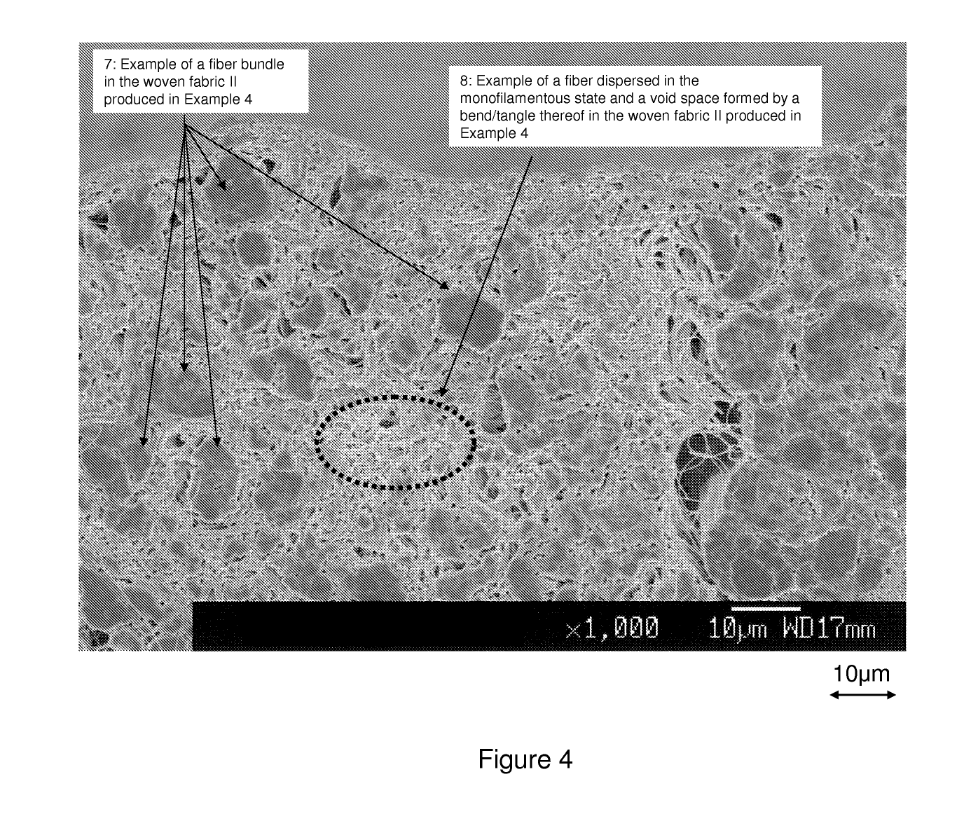

Using the polymer alloy tips obtained in Example 1, melt-spinning was conducted to obtain a highly oriented undrawn yarn of 92 dtex, 36 filaments, followed by drawing and further heat treatment to obtain polymer alloy fiber of 67 dtex, 36 filaments. In the polymer alloy fiber, N6 as an island portion is uniformly dispersed in poly-L-lactic acid as a sea portion and the number average diameter was 110 nm. Using the obtained polymer alloy fiber, a twill woven fabric was produced and then dipped in an aqueous 3% by weight sodium hydroxide solution (95° C., bath ratio of 1:100) for 2 hours, and thus 99% or more of the sea polymer in the polymer alloy fiber was removed by hydrolysis. The thus obtained woven fabric is referred to as a woven fabric I. The number average fiber diameter of the fiber of the woven fabric I was 120 nm. A water flow was injected to the woven fabric I under the same conditions as in Example 2. The thus obtained woven fabric is referred to as a woven fabric II. The woven fabric II was observed by SEM. As a result, the entire surface of the fiber structure is covered with fibers (B) having a number average fiber diameter of 120 nm in a monofilamentous state without clearance. In the cross-section, the fibers (B) having a fiber diameter of 1 μm or less (number average fiber diameter: 110 nm) dispersed in a monofilamentous state form fine void spaces due to interlace or bending and also exist together with a fiber bundle (A) having a fiber bundle diameter of 3 μm or more (number average fiber bundle diameter: 7.3 μm). In FIG. 2, a SEM photograph of a cross-section of the woven fabric II is shown. In FIG. 4, a high-magnification SEM photograph of the same cross-section is shown. The woven fabric II had air permeability of 0 cc/cm²/sec (measurement limit or less). The woven fabric II had a light reflectance of 95%. This woven fabric was laminated on a polyester film using a double-stick tape, followed by slitting to give a tape having a width of 38 mm. The disk was polished under the same conditions as in Example 1. As a result, the disk after polishing showed surface roughness of 0.30 nm and the number of scratches of 0.7 and is extremely excellent in smoothness and low scratch properties.

### Comparative Example 2

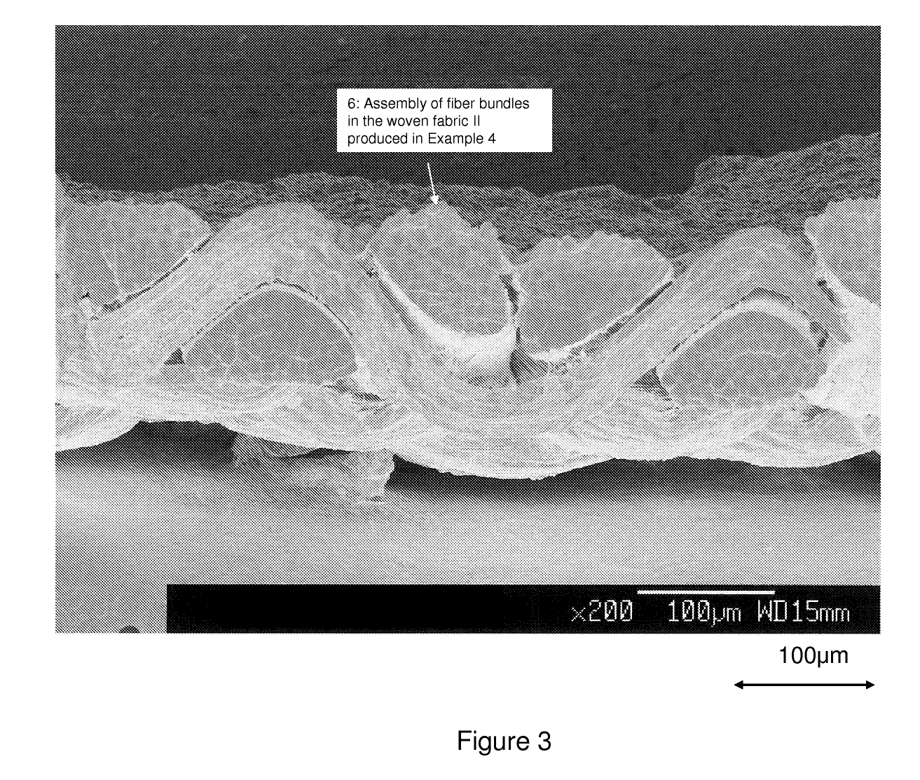

In the same manner as in Example 4, polishing was conducted, except that a laminate obtained by laminating the woven fabric I on a polyester film was used in place of the woven fabric II in Example 4. The woven fabric I was observed by SEM. As a result, a lot of clearances of warp yarns and weft yarns of the woven fabric existed in a state where fibers having a number average fiber diameter of 120 nm form a firm bundle on the surface. In FIG. 3, a SEM photograph of a woven fabric 1 is shown. In the cross-section, only a bundle of fibers having a fiber diameter of 1 μm or less (number average fiber diameter: 120 nm) existed and void spaces of fibers formed by interlace or bending were not observed. The woven fabric I had air permeability of 33 cc/cm²/sec. The woven fabric I had a light reflectance of 60%. The woven fabric was laminated on a polyester film using a double-stick tape, followed by slitting to give a tape having a width of 38 mm. The disk was polished under the same conditions as in Example 1. As a result, the disk after polishing showed surface roughness of 0.43 nm and the number of scratches of 3.5 and is extremely inferior in smoothness and low scratch properties.

The fiber structure according to exemplary embodiments of the present invention can be suitably used for wiping cloths such as eyeglass wipers, and polishing clothes and cleaning tapes used in the manufacturing process of hard disks, silicon wafers, integrated circuit boards, precision instruments, optical components and the like.

1. A fiber structure comprising:
(A) a single fiber having a fiber diameter of 3 μm or more and/or a fiber bundle having a fiber bundle diameter of 3 μm or more, and
(B) a single fiber having a fiber diameter of 1 μm or less, wherein the component (A) has a number average fiber diameter and/or a number average fiber bundle diameter of 4 μm or more, at least a part of the component (B) is dispersed in the component (A) in a monofilamentous state in a cross-section taken in a thickness-wise direction of the fiber structure, at least a part of the component (B) dispersed in the monofilamentous state is bent and/or tangled to form a void space, and at least one surface of the fiber structure is covered with the component (B).

2. The fiber structure according to claim 1, wherein the fiber bundle of the component (A) is composed of single fibers having a number average fiber diameter of 1 μm or less.

3. The fiber structure according to claim 1, wherein the void space formed by a bend and/or a tangle is a void space surrounded only by a fiber whose cross-section cannot be observed, although a fiber whose cross-section can be observed and a fiber whose cross-section cannot be observed exist when the cross-section of the fiber structure is observed on a SEM photograph.

4. The fiber structure according to claim 1, wherein a light reflectance of a surface is 80% or more.

5. The fiber structure according to claim 1, wherein air permeability is 2 cc/cm²/sec or less.

6. A method for production of a fiber structure comprising:
forming a fiber structure containing a polymer alloy fiber composed of a plurality of polymers each having a different solubility;
removing at least one kind of the polymer among the plurality of polymers each having the different solubility of the polymer alloy fiber, to develop an ultrafine fiber having a fiber diameter of 10 to 1,000 nm to give a fiber bundle comprising the assembled ultrafine fibers; and
injecting a high-pressure fluid flow at 0.1 to 20 MPa into the fiber structure containing the fiber bundle comprising the assembled ultrafine fibers.

7. The method for production of a fiber structure according to claim 6, wherein the polymer alloy fiber is obtained by converting the plurality of polymers each having the different solubility into the polymer alloy using an extrusion kneader and/or a static kneader, followed by spinning.

8. The method for production of a fiber structure according to claim 6, wherein the fiber bundle comprising the assembled ultrafine fibers is a fiber bundle in which a number average fiber diameter is from 10 to 300 nm, and a number ratio of the ultrafine fiber having the fiber diameter of 10 to 300 nm is 60% or more.

9. The method for production of a fiber structure according to claim 6, wherein the fiber structure comprises:
(A) a single fiber having a fiber diameter of 3 μm or more and/or a fiber bundle having a fiber bundle diameter of 3 μm or more, and
(B) a single fiber having a fiber diameter of 1 μm or less, wherein the component (A) has a number average fiber diameter and/or a number average fiber bundle diameter of 4 μm or more, at least a part of the component (B) is dispersed in the component (A) in a monofilamentous state in a cross-section taken in a thickness-wise direction of the fiber structure, at least a part of the component (B) dispersed in the monofilamentous state is bent and/or tangled to form a void space, and at least one surface of the fiber structure is covered with the component (B).

10. The method for production of a fiber structure according to claim 6, further comprising conducting a heat treatment at a temperature of 100° C. or higher after injection of the high-pressure fluid flow.
